(19) United States
(12) Patent Application Publication
(10) Pub. No.: US 2014/0088891 A1
(43) Pub. Date: Mar. 27, 2014

(54) METHOD FOR DETERMINING THE PRECISION OF GEARS

(71) Applicant: NATIONAL CENTRAL UNIVERSITY, JHONGLI CITY (TW)

(72) Inventors: YI-CHENG CHEN, JHONGLI CITY (TW); CHIEN-CHENG LO, JHONGLI CITY (TW)

(73) Assignee: NATIONAL CENTRAL UNIVERSITY, JHONGLI CITY (TW)

(21) Appl. No.: 13/953,777

(22) Filed: Jul. 30, 2013

(30) Foreign Application Priority Data
Sep. 21, 2012 (TW) 101134670

(51) Int. Cl. G01H 1/00

(52) U.S. Cl. CPC G01H 1/003
USPC 702/56

(57) ABSTRACT

A method for determining the precision of gears includes steps of providing a gear pair; performing a single flank test for the gear pair, to generate a testing signal graph; decomposing the testing signal graph into a plurality of intrinsic-mode-function graphs; selecting a first function graph and a second function graph from the intrinsic-mode-function graphs; measuring the amplitude of vibration of the first function graph, to get a profile error of gear; combining the first and second function graphs to form a graph of function combination; calculating an adjacent pitch error and an accumulated pitch error by means of the graph of function combination; and defining the gear precision for one of the gear pair according to the profile error of gear, the adjacent pitch error and the accumulated pitch error.

### BACKGROUND OF THE INVENTION

(1) Field of the Invention

The present invention relates to a method for determining the precision of gears, particularly for one can be used in association with a single gear flank tester.

(2) Description of the Prior Art

Currently, conventional gear measuring instrument popularly used in the industry is a kind of gear tester with a probing feeler of miniature ball in touching the flank of the gear tooth for determining the precision of the gear. However, such conventional gear measuring method can be only used for single gear with limitation for specific position on tooth profile, which is not suitable for determining related transmission error for a pair of mating gears (or called gear pair).

Therefore, for gears of high precision and low noise, a single flank gear tester is often used to determining the precision and meshing condition of the gear pair via analyses of the profile error of each gear, accumulated pitch error of gears and adjacent pitch error of gears. With such single flank gear tester, the integrated transmission error of mating gear pair can be quickly determined so that it is suitably used for quality control (QC) in the industry.

For analysis the signals generated by the single flank gear tester, the Fast Fourier Transform (FFT) is usually used with meshing frequency to divide the signals into high frequency and low frequency portions. Wherein, the high frequency portion, which mainly relates to (tooth profile of the gear), is used to determine profile error of gear while the low frequency portion, which mainly relates to deflection of pitch circle in the gear, is used to determine accumulated pitch error of gears. Moreover, the relationship between the frequency and amplitude as well as the related features in the gear precision and transmission noise can be obtained by means of analysis in frequency spectrum for the signals.

The drawback for the Fast Fourier Transform (FFT) aforesaid is that it is difficult to define the meshing condition for the measured gear pair because certain phase shift or phase deviation is incurred by the filtering of wave frequency so that erroneous judgment on the gear precision is almost inevitable. Therefore, how to overcome the difficulty in definition of the meshing condition for the measured gear pair becomes a critical problem for this issue. Thus, the gear precision can be determined in better degree if the difficulty in definition of the meshing condition for the measured gear pair can be solved.

### SUMMARY OF THE INVENTION

The primary object of the present invention is to provide a method for determining the precision of gears so that the meshing condition of a gear pair can be determined in more precise manner to solve the issue of erroneous judgment on the gear precision.

Other objects and advantages of the present invention can be further understood by the technological features disclosed in the exemplary preferred embodiments.

For the purpose of achieving partial/overall or other objects, an exemplary preferred embodiment of the present invention provide a method for determining the precision of gear, which comprises providing a gear pair; providing a single gear flank tester for performing a single gear flank test to the gear pair for generating a testing signal graph; providing an operation unit for receiving and decomposing the testing signal graph into a plurality of preliminary intrinsic-mode-function graphs (IMFs); selecting at least one first intrinsic-mode-function graph (IMF) and another second intrinsic-mode-function graph (IMF) from previous intrinsic-mode-function graphs (IMFs) by the operation unit; obtaining a profile error of gear by the operation unit measuring the amplitude of the first intrinsic-mode-function graph (IMF); the operation unit combining the first intrinsic-mode-function graph (IMF) and second intrinsic-mode-function graph (IMF) for obtaining a graph of function combination; the operation unit calculating out an adjacent pitch error of gears and an accumulated pitch error of gears by means of the graph of function combination; and determining gear precision of the gear pair in accordance with the profile error of gear, adjacent pitch error of gears and accumulated pitch error of gears.

In an exemplary embodiment, the step for decomposing the testing signal graph comprises sub-step of generating a plurality of preliminary intrinsic-mode-function graphs by the operation unit performing Empirical Mode Decomposition (EMD) operating on the previous testing signal graph; the operation unit determine whether there is any mode mixing case in the preliminary intrinsic-mode-function graphs; and if there is a mode mixing case in the preliminary intrinsic-mode-function graphs, decomposing the testing signal graph by the operation unit performing Ensemble Empirical Mode Decomposition (EEMD) to generate the intrinsic-mode-function graphs.

In another exemplary embodiment, the testing signal graph aforesaid provides a first fluctuation frequency to correspond with the periodic variation of the profile error of gear such that the selection of the first intrinsic-mode-function graph (IMF) from previous intrinsic-mode-function graphs (IMFs) is performed by the operation unit comparing the fluctuation frequency of each intrinsic-mode-function graph (IMF) with the first fluctuation frequency. If a specific intrinsic-mode-function graph (IMF) has fluctuation frequency being exactly or nearly same as the first fluctuation frequency, it is defined as first intrinsic-mode-function graph (IMF). Whereas, said testing signal graph also provides a second fluctuation frequency to correspond with the rotational frequency of the gear pair such that the selection of the second intrinsic-mode-function graph (IMF) from previous intrinsic-mode-function graphs (IMFs) is performed by the operation unit comparing the fluctuation frequency of each intrinsic-mode-function graph (IMF) with the second fluctuation frequency. If a specific intrinsic-mode-function graph (IMF) has fluctuation frequency being exactly or nearly same as the second fluctuation frequency, it is defined as second intrinsic-mode-function graph (IMF).

In other words, via comparing the fluctuation frequency of each intrinsic-mode-function graph (IMF) with a meshing frequency and rotational frequency, the first intrinsic-mode-function graph (IMF) and second intrinsic-mode-function graph (IMF) are selected from previous intrinsic-mode-function graphs (IMFs) respectively.

In the other exemplary embodiment, the graph of function combination is a waveform having at least one wave formed with a wave crest and a wave trough, the wave with vibration same as the vibration of the second intrinsic-mode-function graph. Wherein the wave is made of a plurality of pulses mutually linked in a continuity manner, and the vibration of the pulses is the same as the vibration of the first intrinsic-mode-function graph. Thereby, the adjacent pitch error of gears is obtained by the operation unit calculating out the height difference between a pair of adjacent pulses. And, the accumulated pitch error of gears is obtained by the operation unit calculating out the height difference between the wave crest and the wave trough.

By means of the Empirical Mode Decomposition (EMD) used in the method for determining the precision of gears of the present invention, signal of high frequency can be filtered from a short wave. The signal of high frequency is very suitable for used in determine the transmission error as it is less susceptible to noise.

### BRIEF DESCRIPTION OF THE DRAWINGS

FIG. 1 is a schematic view showing a single gear flank tester used by an exemplary preferred embodiment at the method for determining the precision of gears in the present invention.

FIG. 2 is a graphic view showing a testing signal graph from the single gear flank tester used by an exemplary preferred embodiment at the method for determining the precision of gears in the present invention.

FIG. 3 is a diagrammatic flow chart showing all processes in an exemplary preferred embodiment at the method for determining the precision of gears in the present invention.

FIGS. 4A and AB are graphic views showing all intrinsic-mode-function graphs IMF1-IMF12 in an exemplary preferred embodiment at the method for determining the precision of gears in the present invention.

FIG. 5 is a graphic view showing a computing method of the profile error of gear from the graphs obtained by an exemplary preferred embodiment at the method for determining the precision of gears in the present invention.

FIG. 6 is a graphic view showing computing methods of the accumulated pitch error of gears and adjacent pitch error of gears from the graphs obtained by an exemplary preferred embodiment at the method for determining the precision of gears in the present invention.

FIG. 7 is a partial enlarged graphic view showing three characteristic curves of processed results from the graphs obtained by the single gear flank tester in an exemplary preferred embodiment at the method for determining the precision of gears in the present invention that C₁ denotes to a characteristic curve copied from the original testing signal graph, C₂ denotes a characteristic curve converted from the conventional Fast Fourier Transform (FFT) and C₃ denotes a characteristic curve converted from the Empirical Mode Decomposition (EMD) of the present invention.

### DESCRIPTION OF THE PREFERRED EMBODIMENTS

In the following detailed description of the preferred embodiments, reference is made to the accompanying drawings which form a part hereof, and in which is shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component facing “B” component directly or one or more additional components is between “A” component and “B” component. Also, the description of “A” component “adjacent to” “B” component herein may contain the situations that “A” component is directly “adjacent to” “B” component or one or more additional components is between “A” component and “B” component. Accordingly, the drawings and descriptions will be regarded as illustrative in nature and not as restrictive.

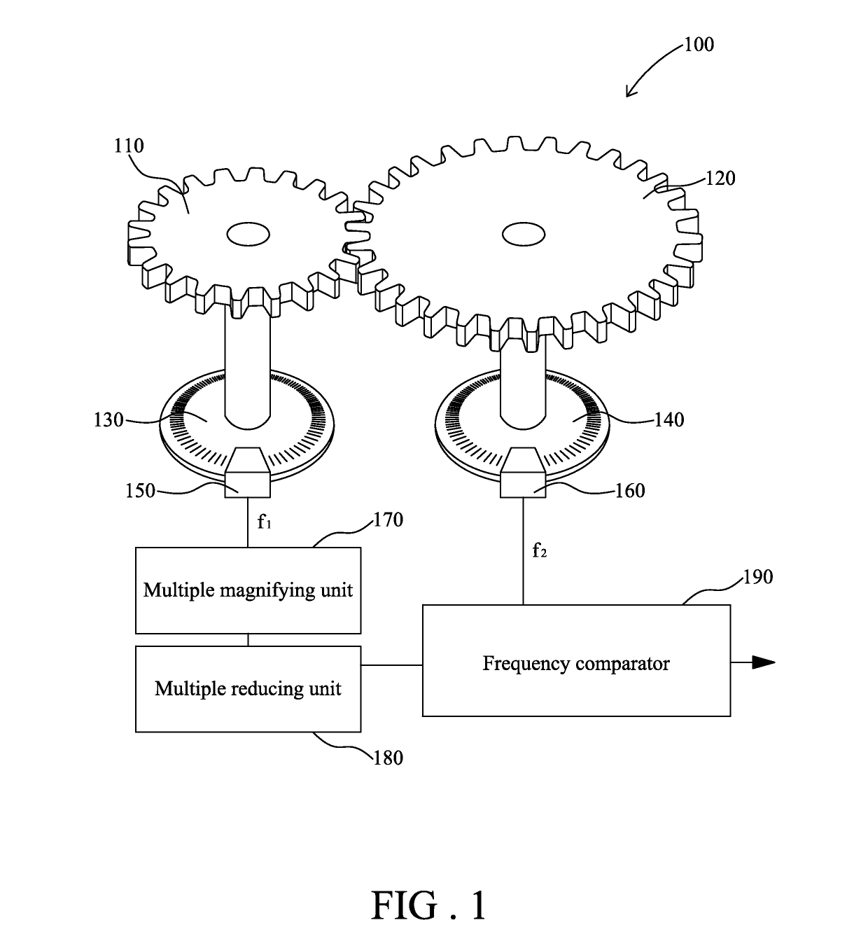

Please refer to FIG. 1, which is a schematic view showing a single gear flank tester 100 used by an exemplary preferred embodiment at the method for determining the precision of gears in the present invention. The single gear flank tester 100 mainly comprises a pair of mating and meshing gears (or called gear pair) containing an active gear 110 (or called driving gear) and a passive gear 120 (or called driven gear) for transmitting torque with specific gear ratio and speed ratio in effective and smooth manner theoretically. However, in practically, certain intermittence may happen in the meshing action of the mating gear pair incurred by assembly error and process error. Then, the intermittence is defined as transmission error of gear pair (Δφ₂) with following formulas:

$$\begin{matrix}{φ}_{2} = \frac{{Z}_{1}}{{Z}_{2}} {φ}_{1} & Formula 1 \\ {Δφ}_{2} = {φ}_{2}^{′} - {φ}_{2} = {φ}_{2}^{′} - \frac{{Z}_{1}}{{Z}_{2}} {φ}_{1} & Formula 2\end{matrix}$$

Where the (φ₁) denotes to an actual rotational angle of the active gear 110 while the (φ′₂) denotes to an actual rotational angle of the passive gear 120, and the (φ₂) denotes to a theoretical rotational angle of the passive gear 120. The (Z₁) denotes to the tooth number of the active gear 110 while the (Z₂) denotes to the tooth number of the passive gear 120. A ratio for the tooth number of the passive gear 120 (Z₂) to the tooth number of the active gear 110 (Z₁) as shown in foregoing formula 1. Whereas the theoretical rotational angle of the passive gear 120 (φ₂) is calculated from formula 1. The transmission error of gear pair (Δφ₂) is the difference between the actual rotational angle (φ′₂) and the theoretical rotational angle (φ₂) of the passive gear 120.

As shown in FIG. 1, an angular encoder 130 (or called rotary encoder) is linked to the active gear 110 while another angular encoder 140 is linked to the passive gear 120. By means of the angular encoder 130 and angular encoder 140, the actual rotational angles of the active gear 110 (φ₁) and the actual rotational angles of the passive gear 120 (φ′₂) are precisely calculated respectively so that the transmission error of gear pair (Δφ₂) is further calculated out according to foregoing formulas 2.

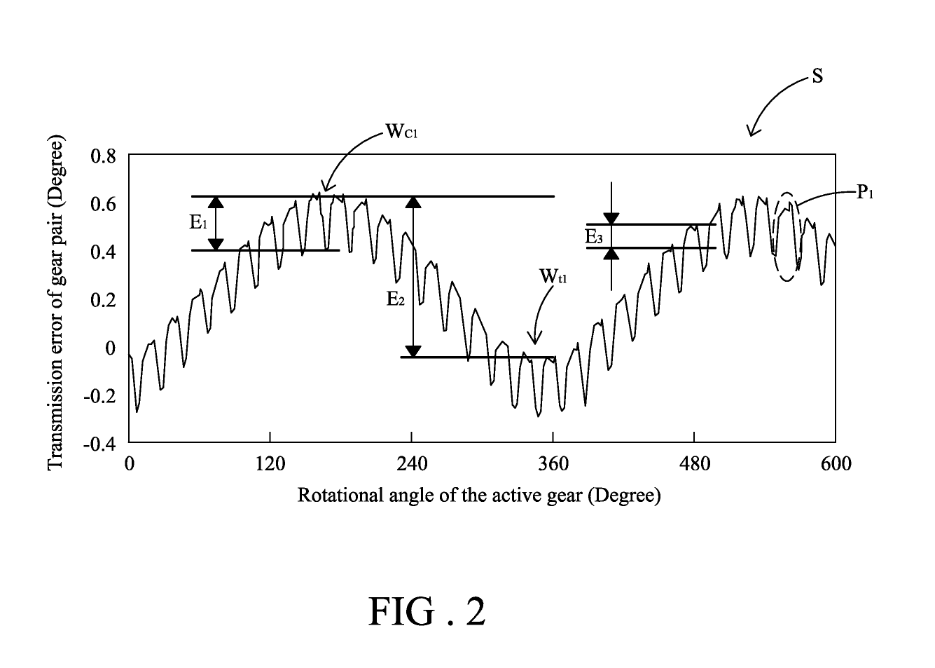

In this exemplary preferred embodiment, the actual rotational angles (φ₁) of the active gear 110 and the actual rotational angles (φ′₂) the passive gear 120, which are calculated by the angular encoder 130 and the angular encoder 140 respectively, are converted into pulse waves of frequencies f₁ and f₂ by a reading head 150 (or called accessing head) and a reading head 160 respectively. The pulse wave of frequency f₂ is directly inputted into a frequency comparator 190 while the pulse wave of frequency f₁ is firstly magnified into magnifying multiples Z₁ by a multiple magnifying unit 170, secondly reduced into reducing multiples Z₂ by a multiple reducing unit 180, and finally inputted into the frequency comparator 190 too. Thus, a testing signal graph S is obtained after the pulse waves of frequencies f₁ and f₂ of the active gear 110 and passive gear 120 are processed by the frequency comparator 190 (as shown in FIG. 2).

Please refer to FIG. 2, which is a graphic view showing a typical testing signal graph S from the single gear flank tester 100 used by an exemplary preferred embodiment at the method for determining the precision of gears in the present invention. In the testing signal graph S, the vertical axis (or called Y-coordinate) indicates the transmission error Δφ₂ of gear pair, while the horizontal axis (or called X-coordinate) indicates the rotational angle of the active gear 110. The testing signal graph S is a waveform having at least one wave with envelope made of a plurality of pulses P₁ mutually linked in a continuity manner. In other words, the continue pulses arrange as a wave with at least one wave crest Wc₁ and at least one wave trough Wt₁ due to the deflection. Some useful information for defining gear precision such as profile error of gear E₁, adjacent pitch error of gears E₃ and accumulated pitch error of gears E₂ can be obtained from the decomposition of the transmission error of gear pair Δφ₂. Wherein the testing signal graph S, the profile error of gear E₁ is defined as the height of each pulse (P₁), the adjacent pitch error of gears E₃ is defined as the height difference between each pair of adjacent pulses and the accumulated pitch error of gears E₂ is defined as height difference between the wave crest (Wc₁) and wave trough (Wt₁) of the waveform.

From the envelope of the testing signal graph S, all the profile error of gear E₁, adjacent pitch error of gears E₃ and accumulated pitch error of gears E₂ appear in periodic fluctuation manner with each different period respectively. A second fluctuation frequency is calculated by one of the rotational frequency form either active gear 110 or passive gear 120 while a first fluctuation frequency is calculated by the period of profile error of gear E₁, which relates to the meshing frequency of active gear 110 or passive gear 120.

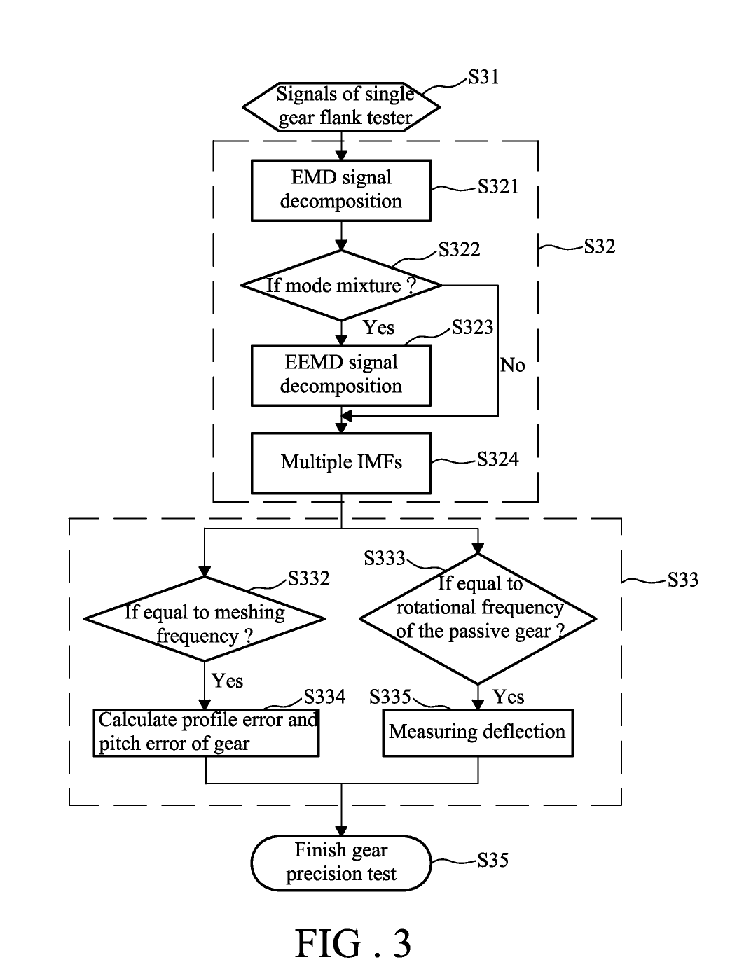

Please refer to FIG. 3, which is a diagrammatic flow chart showing all processes in an exemplary preferred embodiment at the method for determining the precision of gears in the present invention. Generally, step S31 refers to initial signals of the single gear flank tester 100 obtained and used in the present invention; step S32, which is a processing block including steps S321, S322, S323 and S324, refers to generation of a plurality of Intrinsic Mode Function (IMF) by an operation unit performing Empirical Mode Decomposition (EMD) or Ensemble Empirical Mode Decomposition (EEMD) so that a suitable Intrinsic Mode Function (IMF) with optimal fluctuation frequency is selected for following comparison process; step S33, which is also a processing block including steps S332, S333, S334 and S335, refers to comparing the optimal fluctuation frequency of selected Intrinsic Mode Function (IMF) with meshing frequency and rotational frequency respectively to calculate out the profile error of gear E₁, adjacent pitch error of gears E₃ and accumulated pitch error of gears E₂; and step S35 refers to finish the test for determining the precision of gears by the single gear flank tester 100 used in the present invention. Detailed description for process in each step is disclosed as below.

In step S31, after the testing signal graph S is obtained from the frequency comparator 190 via processing the pulse waves of frequencies f₁ and f₂ of the active gear 110 and passive gear 120 (as shown in FIG. 2), then the flowing process goes to step S321.

In step S321, after a plurality of preliminary intrinsic-mode-function graphs (IMFs) with complicated periodic signals are generated by the operation unit performing Empirical Mode Decomposition (EMD) operating on the previous testing signal graph S, then the flowing process goes to step S322.

In step S322, determine whether there is any mode mixing case, then the flowing process goes to step S323 if judgment is “Yes” otherwise it goes to step S324 if judgment is “No”.

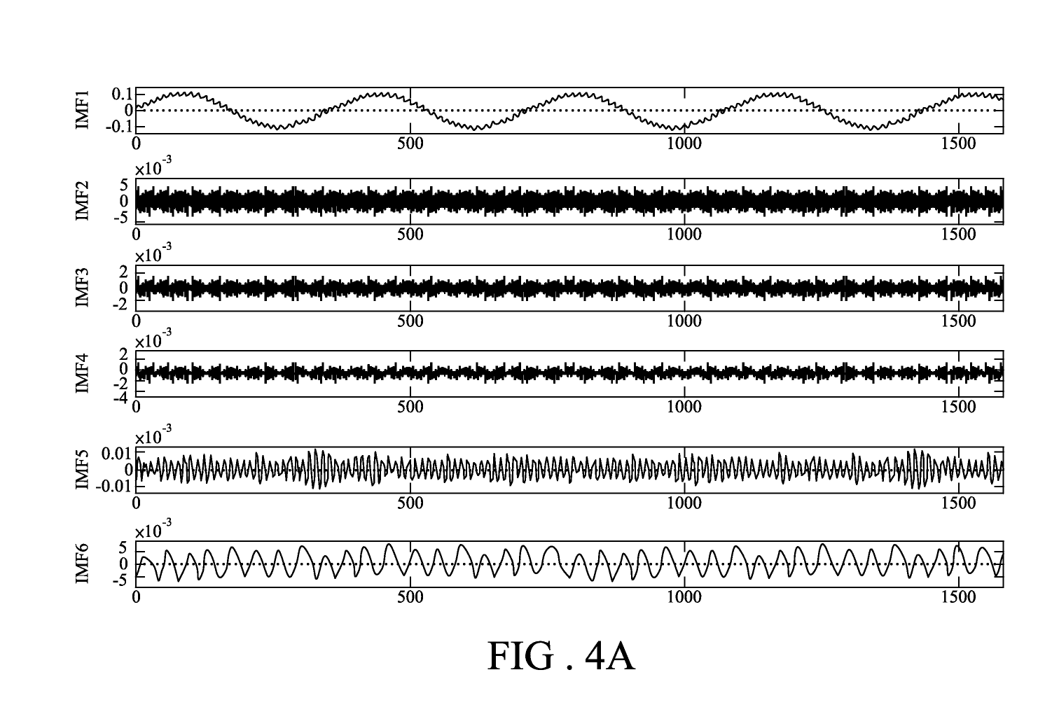

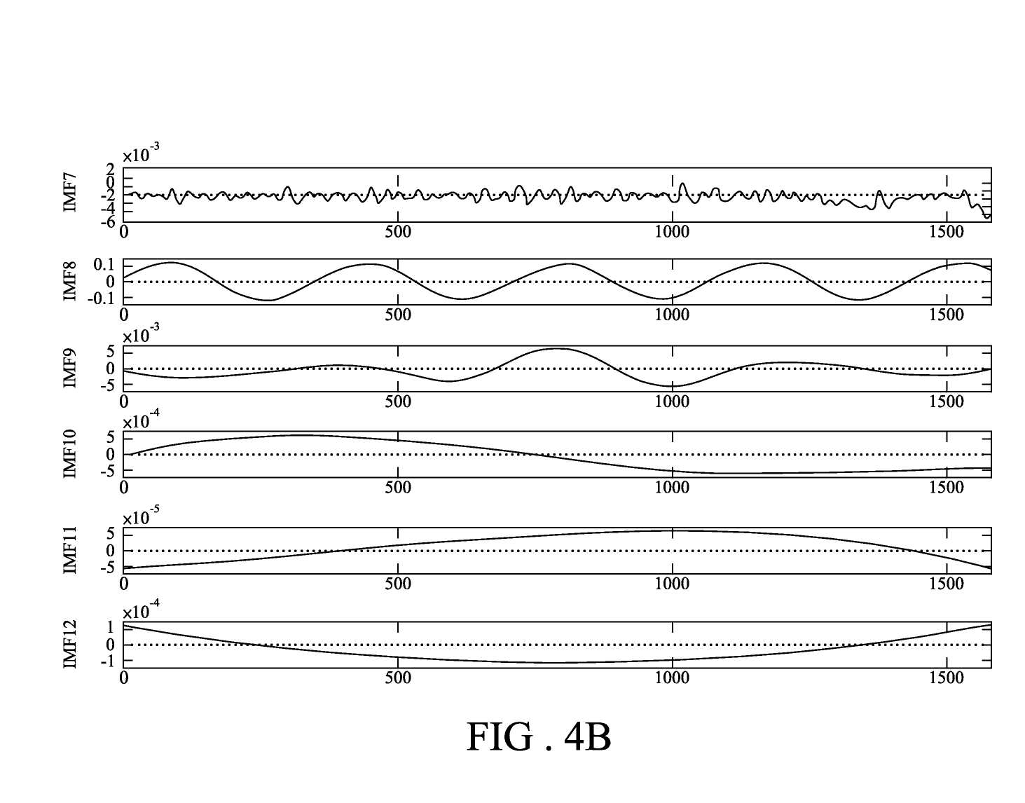

In step S323, if there is one mode mixing case in the preliminary intrinsic-mode-function graphs (IMFs), the previous testing signal graph S is decomposed by the operation unit performing Ensemble Empirical Mode Decomposition (EEMD), so as to generate a plurality of final intrinsic-mode-function graphs (IMF1-IMF12) (as shown in FIGS. 4A and AB), then the flowing process goes to step S324.

In step S324, for the operation unit selecting an optimal intrinsic-mode-function graphs (IMFs), which has fluctuation frequency with exactly or nearly same as the meshing frequency or rotational frequency, from previous plural final intrinsic-mode-function graphs (IMF1-IMF12) for analysis, the flowing process is branched to step S332 and step S333 nested in the S33 for working out profile error of gear E₁, adjacent pitch error of gears E3 and accumulated pitch error of gears E₂.

In branching step S332, the operation unit determine whether each intrinsic-mode-function graphs (IMF) of previous plural final intrinsic-mode-function graphs (IMF1-IMF12) has fluctuation frequency with exactly or nearly same as the meshing frequency of the gear pair, then the specific intrinsic-mode-function graph (IMF) is selected for analysis and the flowing process goes to step S334 if judgment is “Yes” otherwise it is discarded if judgment is “No”.

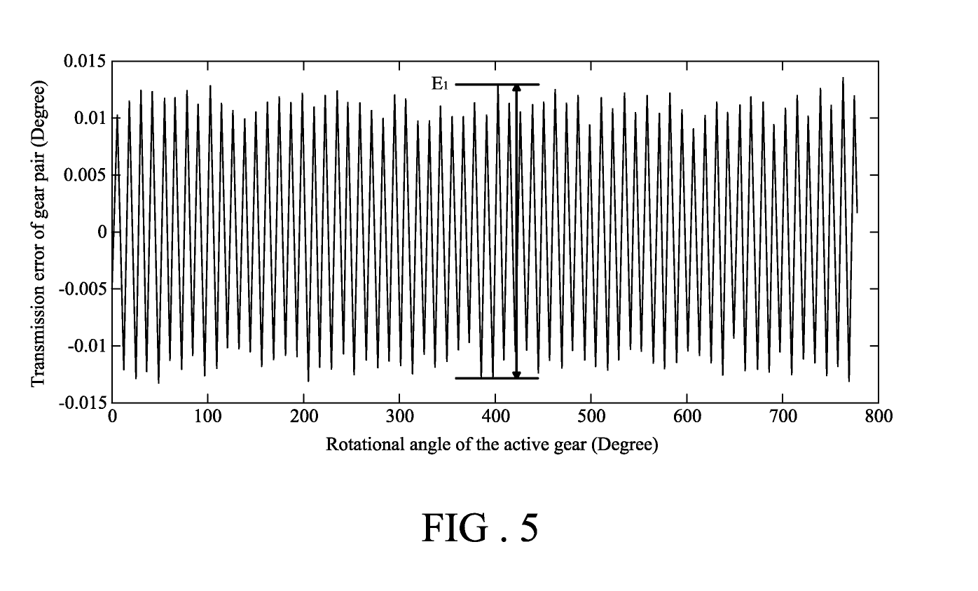

In step S334, after the profile error of gear E₁ is calculated out according to that it is defined as the height of each pulse (as shown in FIG. 5), here, a first intrinsic-mode-function graph (IMF) is defined if its fluctuation frequency is exactly or nearly same as the meshing frequency of the gear pair while a second intrinsic-mode-function graph (IMF) is defined if its fluctuation frequency is exactly or nearly same as the rotational frequency of the gear pair, then the flowing process goes to step S35.

In branching step S333, the operation unit determine whether each intrinsic-mode-function graphs (IMFs) of previous plural final intrinsic-mode-function graphs (IMF1-IMF12) has fluctuation frequency with exactly or nearly same as the meshing frequency and rotational frequency for a graph of function combination F of the gear pair, then the specific intrinsic-mode-function graph (IMF) is selected for analysis and the flowing process goes to step S335 if judgment is “Yes” otherwise it is discarded if judgment is “No”, wherein the graph of function combination F is a combination of one specific first intrinsic-mode-function graph (IMF) and another second specific intrinsic-mode-function graph (IMF).

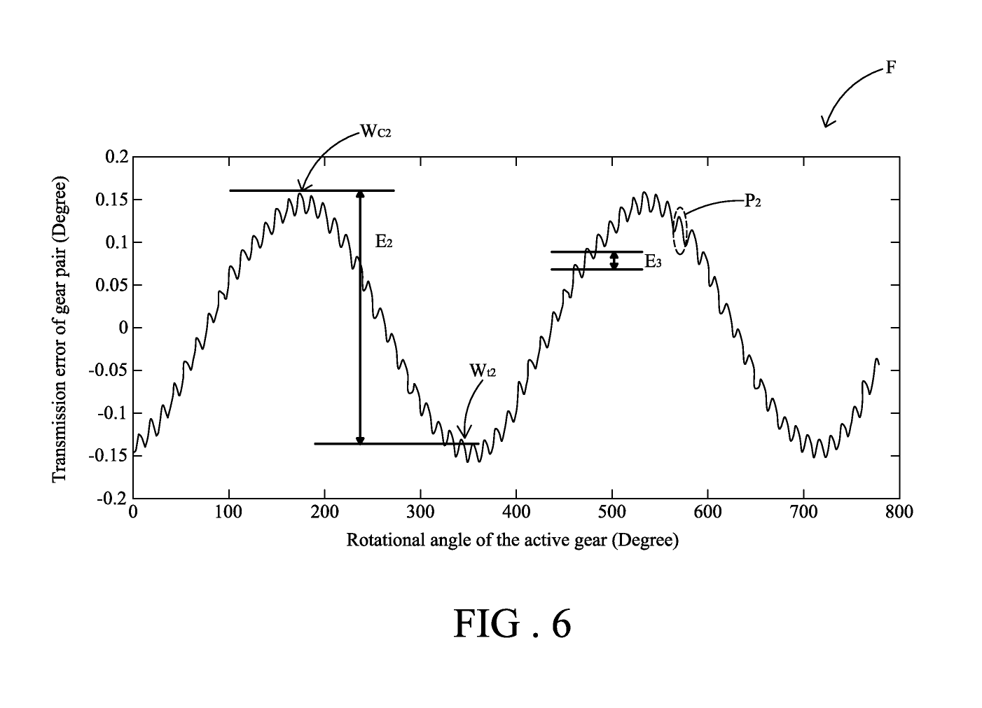

In step S335, after the adjacent pitch error of gears E₃, accumulated pitch error of gears E₂ and measuring deflection are calculated out according individual definition respectively (as shown in FIG. 6), then the flowing process goes to step S35.

In step S35, the gear precision is determined on the basis of profile error of gear E₁, adjacent pitch error of gears E₃ and accumulated pitch error of gears E₂, then the overall flowing processes for testing gear precision of the gear pair is completed.

Please refer to FIGS. 4A and 4B, which are graphic views showing all intrinsic-mode-function graphs IMF1-IMF12 in an exemplary preferred embodiment at the method for determining the precision of gears in the present invention. By means of Empirical Mode Decomposition (EMD) operating on the testing signal graph S, a plurality of intrinsic-mode-function graphs (IMF1-IMF12) covering high frequency and low frequency (as shown in FIGS. 4A and AB) are obtained. Moreover, by means of Hilbert-Huang Transform (HHT) operating on the previous plural intrinsic-mode-function graphs (IMF1-IMF12), an integral distribution for frequency-time graph with instantaneous frequency and instantaneous amplitude is further obtained so that the analysis in relationship for the signal frequency changing with time is enabled. Thus, even complicated data or signals that are non-stationary and nonlinear, the methods used here work well for complete analysis.

Please refer to FIG. 5, which is a graphic view showing a computing method of the profile error of gear E₁ from the graphs obtained by an exemplary preferred embodiment at the method for determining the precision of gears in the present invention. In FIG. 5, only intrinsic-mode-function graph (IMF) has fluctuation frequency with same as the meshing frequency of the gear pair is selected to match with the definition of the profile error of gear E₁ that it is defined as the height (or amplitude) of each pulse (as shown in FIG. 5). In other words, the profile error of gear E₁ is calculated out by means of measuring the height (or amplitude) of each pulse in the intrinsic-mode-function graphs (IMFs).

Please refer to FIG. 6, which is a graphic view showing computing methods of the accumulated pitch error of gears E₂ and adjacent pitch error of gears E₃ from the graphs obtained by an exemplary preferred embodiment at the method for determining the precision of gears in the present invention. A graph of function combination F is obtained by combination of one first specific intrinsic-mode-function graph (IMF) has fluctuation frequency with exactly or nearly same as the meshing frequency of the gear pair and another second specific intrinsic-mode-function graph (IMF) has fluctuation frequency with exactly or nearly same as the rotational frequency of the gear pair (as shown in FIG. 6). By means of the graph of function combination F, the adjacent pitch error of gears E₃ and accumulated pitch error of gears E₂ are calculated out so that the gear precision is exactly determined.

In another exemplary preferred embodiment, the graph of function combination F is a waveform having at least one wave crest Wc₂ and one wave trough Wt₂ with vibration frequency same as that of the second intrinsic-mode-function graph, so as to form at least one wave; the wave with envelope made of a plurality of pulses P₂ mutually linked in a continuity manner, and the vibration frequency of the pulses P₂ is the same as that of the first intrinsic-mode-function graph. Thus, the adjacent pitch error of gears E₃ is calculated out via the height difference between a pair of adjacent pulses P₂ while the accumulated pitch error of gears E₂ is calculated out via the height difference between the wave crest (Wc₂) and wave trough (Wt₂) of a specific wave.

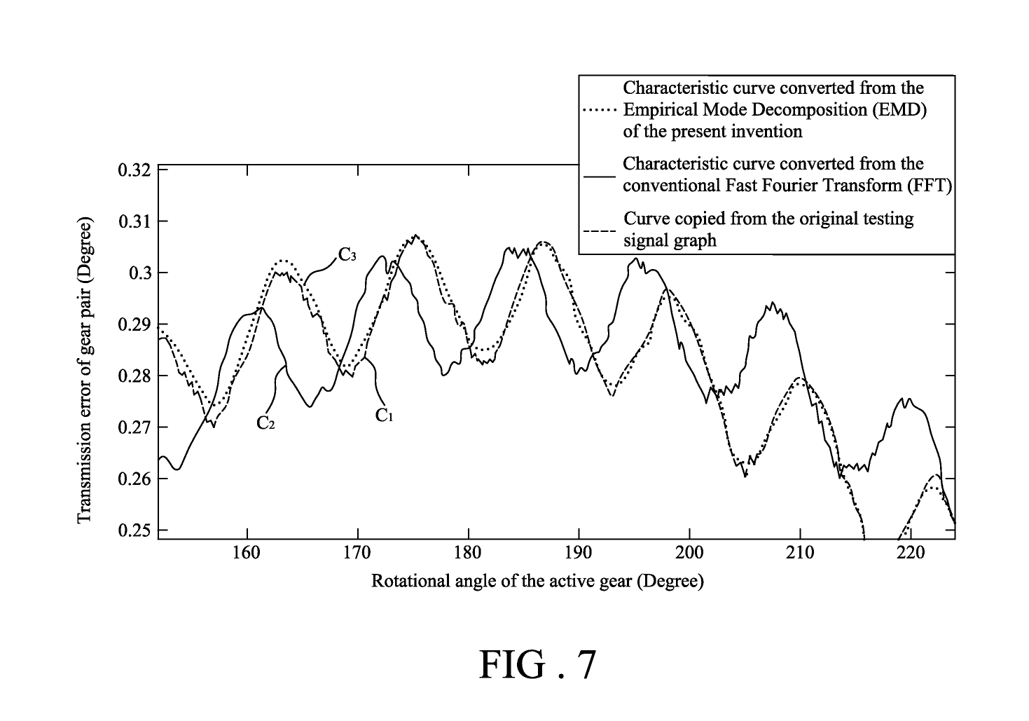

Please refer to FIG. 7, which is a partial enlarged graphic view showing three characteristic curves of processed results from the graphs obtained by the single gear flank tester in an exemplary preferred embodiment at the method for determining the precision of gears in the present invention that C₁ denotes to a characteristic curve copied from the original testing signal graph, C₂ denotes a characteristic curve converted from the conventional Fast Fourier Transform (FFT) and C₃ denotes a characteristic curve converted from the Empirical Mode Decomposition (EMD) of the present invention. The exemplary preferred embodiment illustrates the testing results for a gear pair of two spur gears with 30 tooth numbers respectively by the single gear flank tester, wherein curve C₁ is original testing signal graph S, which is also a partially enlarged view for the testing signal graph S in FIG. 2; curve C₂ is a graph of function combination for filtered high and low frequencies by means of conventional Fast Fourier Transform (FFT) operating on the original testing signal graph S; and curve C₃ is a graph of function combination for filtered high and low frequencies by means of the Empirical Mode Decomposition (EMD) of the present invention operating on the original testing signal graph S, which is also a partially enlarged view for the graph of function combination F in FIG. 6. From FIG. 7, it is apparent that a rather phase shift relative to the curve C₁ exists in the filtered curve C₂ by conventional Fast Fourier Transform (FFT) while no such phase shift relative to the curve C₁ exists in the filtered curve C₃ by the Empirical Mode Decomposition (EMD) of the present invention. Thus, the filtered curve C₃ by the Empirical Mode Decomposition (EMD) of the present invention is almost consistent with the curve C₁ of original testing signal graph S.

The foregoing description of the preferred embodiment of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like is not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A method for determining the precision of gears comprising steps of:
providing a gear pair;
providing a single gear flank tester for performing a single gear flank test to the gear pair for generating a testing signal graph;
providing an operation unit for receiving and decomposing the testing signal graph into a plurality of intrinsic-mode-function graphs (IMFs);
selecting a first intrinsic-mode-function graph and a second intrinsic-mode-function graph from previous intrinsic-mode-function graphs by the operation unit;
obtaining a profile error of gear by the operation unit measuring the amplitude for the vibration of the first intrinsic-mode-function graph;
obtaining a graph of function combination by the operation unit combining the first intrinsic-mode-function graph and the second intrinsic-mode-function graph;
the operation unit calculating out an adjacent pitch error of gears and an accumulated pitch error of gears by means of the graph of function combination; and
determining gear precision for one of the gear pair in accordance with the profile error of gear, the adjacent pitch error of gears and the accumulated pitch error of gears.

2. The method for determining the precision of gears of claim 1, wherein the step for decomposing the testing signal graph comprises sub-step of:
the operation unit generating a plurality of preliminary intrinsic-mode-function graphs by means of Empirical Mode Decomposition (EMD) operating on the previous testing signal graph;
the operation unit determine whether there is any mode mixing case in the preliminary intrinsic-mode-function graphs; and
if there is a mode mixing case in the preliminary intrinsic-mode-function graphs, the operation unit decomposing the testing signal graph by means of Ensemble Empirical Mode Decomposition (EEMD) to generate the intrinsic-mode-function graphs.

3. The method for determining the precision of gears of claim 1, further comprising a step of determining whether each of the intrinsic-mode-function graphs has one fluctuation frequency with same as one meshing frequency of the gear pair by the operation unit.

4. The method for determining the precision of gears of claim 1, further comprising a step of determining whether each of the intrinsic-mode-function graphs has one fluctuation frequency with same as one rotational frequency of the gear pair by the operation unit.

5. The method for determining the precision of gears of claim 1, wherein the testing signal graph provides a first fluctuation frequency to correspond with the periodic variation of the profile error of gear such that the selection of the first intrinsic-mode-function graph from previous intrinsic-mode-function graphs comprises steps of:
comparing the fluctuation frequency of each of the intrinsic-mode-function graphs with the first fluctuation frequency; and
defining one specific intrinsic-mode-function graph with fluctuation frequency closest to the first fluctuation frequency as the first intrinsic-mode-function graph.

6. The method for determining the precision of gears of claim 5, wherein the testing signal graph provides a second fluctuation frequency to correspond with the rotational frequency of the gear pair such that the selection of the second intrinsic-mode-function graph from previous intrinsic-mode-function graphs comprises steps of:
comparing the fluctuation frequency of each of the intrinsic-mode-function graphs with the second fluctuation frequency; and
defining one specific intrinsic-mode-function graph with fluctuation frequency closest to the second fluctuation frequency as the second intrinsic-mode-function graph.

7. The method for determining the precision of gears of claim 1, wherein the graph of function combination is a waveform having at least one wave formed with a wave crest and a wave trough, the wave with vibration same as the vibration of the second intrinsic-mode-function graph, wherein the wave is made of a plurality of pulses mutually linked in a continuity manner, and the vibration of the pulses is the same as the vibration of the first intrinsic-mode-function graph, whereby, the step of calculating out the adjacent pitch error of gears comprises sub-step of:
calculating out the height difference between a pair of adjacent pulses to be defined as the adjacent pitch error of gears.

8. The method for determining the precision of gears of claim 7, wherein the step of calculating out the accumulated pitch error of gears comprises sub-step of:
calculating out the height difference between the wave crest and the wave trough to be defined as the accumulated pitch error of gears.
